(19) United States
(12) Patent Application Publication
(10) Pub. No.: US 2024/0064532 A1
(43) Pub. Date: Feb. 22, 2024

(54) Using a Classification Model to Make Network Configuration Recommendations for Improved Mobility Performance

(71) Applicant: Telefonaktiebolaget LM Ericsson (publ), Stockholm (SE)

(72) Inventors: Jaime Rodriguez Membrive, Malaga (ES); Raul Martin Cuerdo, Madrid (ES); Karan Rampal, Stockholm (SE); Javier Rasines, Solna (SE); Juan Pablo Poujade Ramilo, Malaga (ES)

(21) Appl. No.: 18/267,318

(22) PCT Filed: May 28, 2021
(86) PCT No.: PCT/IB2021/054700

§ 371 Date: Jun. 14, 2023

(30) Foreign Application Priority Data
Jan. 28, 2021 (EP) 21382069.9

(51) Int. Cl. H04W 24/02; H04W 16/22

(52) U.S. Cl. CPC H04W 24/02; H04W 16/22

(57) ABSTRACT

A computing device (110) generates, from a network graph representing a plurality of network elements in a wireless communication network (100) and based on a plurality of network performance metrics, a model of the wireless communication network (100) that groups the network elements having similar radio environments (170) together. The computing device (110) also generates a network configuration recommendation (370) for at least one of the network elements based on the model.

### TECHNICAL FIELD

This application generally relates to the field of wireless communication, and more particularly relates to techniques for determining network configurations that improve device mobility in a wireless communication network.

### BACKGROUND

Long Term Evolution (LTE) networks, for example, have significantly increased in complexity over time. It is common for multiple frequencies layers to be present in each operator network. Due to this complexity, layer management optimization is a key activity for operators in modern networks. An important goal of this optimization is to provide the best experience to users of the LTE network, in the most efficient manner practicable, by serving each UE in the best frequency based on its needs with respect to throughput, latency, radio conditions, etc.

There are a set of Radio Access Network (RAN) features that allow operators to configure and tune the mobility process in order to better serve users. However, even for very small numbers of nodes within a RAN, mobility optimization and tuning traditionally requires studying a huge amount of data, including network statistics, network configuration parameters, the radio frequency (RF) environment, and the network topology. Further, even after such study is performed, traditional methods are often only able to successfully optimize one or a small number of parameters.

Traditionally, mobile operators analyze various items and make recommendations by applying basic rules or pre-determined thresholds to performance metrics. Such approaches are typically limited to configurations that have been validated solely within the network and are based on personnel experience. Due to these limitations and the complexity of the problem domain, operators often have a single and default mobility strategy for all network elements (e.g., cells) of the same layer, which can often fall far short of the optimization goal, particularly at scale.

### SUMMARY

Embodiments of the present disclosure are generally directed to a computing device that uses a classification model to generate network configuration recommendations intended to improve mobility performance.

Embodiments of the present disclosure include a method implemented by a computing device. The method comprises generating, from a network graph representing a plurality of network elements in a wireless communication network and based on a plurality of network performance metrics, a model of the wireless communication network that groups the network elements having similar radio environments together. The method further comprises generating a network configuration recommendation for at least one of the network elements based on the model.

In some embodiments, generating the model is further based on configurations of the network elements.

In some embodiments, the method further comprises generating the network graph from at least one signal quality threshold for each of a plurality of handover events for each of the network elements.

In some embodiments, the method further comprises receiving configuration and performance metric data describing the wireless communication network, and generating the network graph from the configuration and performance metric data.

In some embodiments, generating the model is further based on a training set of configurations for the radio environments. In some such embodiments, the method further comprises integrating the network configuration recommendation into the training set, regenerating the model based on the integrated training set, and generating a further network configuration recommendation based on the regenerated model.

In some embodiments, the method further comprises identifying, as behavioral outliers, one or more network elements that are represented in the network graph and omitted from the groups of network elements having similar radio environments. Generating the network configuration recommendation based on the model comprises generating the network configuration recommendation based on a portion of the model that excludes the one or more network elements identified as behavioral outliers.

In some embodiments, the method further comprises applying rule-based criteria to determine whether configuring the wireless communication network in accordance of the network configuration recommendation would produce a mobility ping-pong effect.

In some embodiments, the method further comprises aggregating the network performance metrics into fewer network performance metrics. Generating the model based on the plurality of network performance metrics is responsive to determining the radio environments that are similar based on the fewer network performance metrics.

In some embodiments, the network graph representing the plurality of network elements in the wireless communication network further represents a plurality of operator networks, each of which comprises at least one of the network elements.

In some embodiments, generating the model that groups the network elements having similar radio environments together comprises determining a preliminary group of network elements, and identifying at least two of the groups of network elements from within the preliminary group of network elements. The at least two of the groups have radio environments are different from each other.

In some embodiments, generating the network configuration recommendation for the at least one of the network elements comprises generating the network configuration recommendation for one of the groups of network elements having a similar radio environment.

In some embodiments, the network configuration recommendation comprises an indication of whether the network configuration recommendation is predicted to accelerate or delay mobility within the wireless communication network.

In some embodiments, the network configuration recommendation comprises a recommended threshold for triggering a mobility event.

In some embodiments, the network configuration recommendation comprises an indication of a predicted performance impact that will be caused by adopting the network configuration recommendation.

In some embodiments, the network configuration recommendation comprises an confidence metric indicating a probability that the predicted performance impact is accurate.

In some embodiments, the network configuration recommendation comprises a probability that the radio environment of the at least one of the network elements for which the network configuration recommendation was generated is a behavioral outlier relative to the groups of network elements having similar radio environments.

In some embodiments, the method further comprises providing the network configuration recommendation to a user of the computing device.

In some embodiments, the method further comprises modifying a configuration of the at least one of the network elements in accordance with the network configuration recommendation.

Other embodiments include a computing device configured to generate, from a network graph representing a plurality of network elements in a wireless communication network and based on a plurality of network performance metrics, a model of the wireless communication network that groups the network elements having similar radio environments together. The computing device is further configured to generate a network configuration recommendation for at least one of the network elements based on the model.

In some embodiments, the computing device is further configured to perform any of the method described above.

In some embodiments, the computing device comprises processing circuitry and a memory. The memory contains instructions executable by the processing circuitry whereby the computing device is configured.

Other embodiments include a computer program, comprising instructions which, when executed on processing circuitry of a computing device, cause the processing circuitry to carry out any of the methods described above.

Yet other embodiments include a carrier containing such a computer program. The carrier is one of an electronic signal, optical signal, radio signal, or computer readable storage medium.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter according to one or more embodiments, whereas discussion of a specific instance of an illustrated element will append a letter designation thereto (e.g., discussion of a wireless device 160, generally, as opposed to discussion of particular instances of wireless devices 160a, 160b).

FIG. 1 is a schematic illustrating an example wireless communication network, according to one or more embodiments of the present disclosure.

FIG. 2 is a schematic illustrating an example computing device, according to one or more embodiments of the present disclosure.

FIG. 3 is a flow diagram illustrating an example of processing performed to generate a network configuration recommendation, according to one or more embodiments of the present disclosure.

FIG. 4 is a table listing example configuration parameters, according to one or more embodiments of the present disclosure.

FIG. 5 is a schematic illustrating an example network graph, according to one or more embodiments of the present disclosure.

FIG. 6 is a flow diagram illustrating an example of processing performed to generate a network configuration recommendation, according to one or more embodiments of the present disclosure.

FIG. 7 is a flow diagram illustrating an example of processing performed to train a model, according to one or more embodiments of the present disclosure.

FIG. 8 is a table of values used to validate a model, according to one or more embodiments of the present disclosure.

FIG. 9 is a flow diagram illustrating an example of processing performed in accordance with a U-net architecture to detect a behavior outlier, according to one or more embodiments of the present disclosure.

FIG. 10 is a graph illustrating an example of distribution error, according to one or more embodiments of the present disclosure.

FIG. 11 is a graph illustrating an example of outlier probability, according to one or more embodiments of the present disclosure.

FIG. 12 illustrates an example of processing performed to estimate performance via a neural network regressor function, according to one or more embodiments of the present disclosure.

FIG. 13 is a graph illustrating an example outcome of evaluating a neural network regressor function on a test set, according to one or more embodiments of the present disclosure.

FIG. 14 is a table that contrasts a baseline configuration against a recommended configuration, according to one or more embodiments of the present disclosure.

FIG. 15 is a flow diagram illustrating an example method implemented by a computing device, according to one or more embodiments of the present disclosure.

FIG. 16 is a schematic block diagram illustrating an example of a computing device, according to one or more embodiments of the present disclosure.

### DETAILED DESCRIPTION

Embodiments of the present disclosure analyze and identify similar radio environments that are suitable for optimization collectively from the large and more complex arrangement of radio environments produced by a wireless network as a whole. Each cluster of these similar radio environments presents a more manageable optimization problem to engineers, while also enabling consideration of a broader array of performance-relevant factors for the cluster than can generally be considered using traditional approaches.

In this regard, particular embodiments automate and improve layer management relative to alternatives through the use of artificial intelligence techniques. Particular techniques proposed herein involve a computing device that learns how to manage the complexity of the overall network problem domain and automatically makes one or more decisions regarding the overall network management strategy.

Although the optimizations made based on the clusters identified by particular embodiments may, in some cases, be applied to enhance load balancing in the network, this disclosure will generally focus on optimizations that improve user experience indicators including, for example, reducing dropped calls and/or improving data throughput. Such optimizations may generally be achieved by adjusting one or more processes that control network users that are experiencing poor radio conditions. These adjustments may, for example, be performed by changing a network configuration that relates to device mobility for one or more network elements. In many cases, improving the movement of users that are experiencing poor radio conditions can yield significant benefits to overall network performance.

For clarity, throughout this disclosure the term “optimization” and its variants (e.g., “optimize,” “optimal”) do not necessarily refer to a change that produces the absolute best result that is mathematically possible. Rather, throughout this disclosure, the term “optimization” and its variants refer to a change that produces an efficiency improvement that is better than known or available alternatives. It will be appreciated than an optimization that produces an improvement in one respect may produce less optimal results in one or more other respects. In such a circumstance, the value of the improvement obtained by the optimization is considered more beneficial its cost(s).

The embodiments of the present disclosure may be particularly useful in wireless networks that adhere to Third Generation Partnership Project (3GPP) standards. Examples of a such a network in include an LTE and/or 5G New Radio (NR) network. That said, the embodiments described herein may be applied to multiple network technologies, including non-3GPP standard networks. Notwithstanding, particular embodiments may, for example, be used in the initial tuning of NR networks with multiple layers, and support operators in this activity by means of specific recommendations based on learned optimal configurations on NR layers, for example.

Broadly stated, certain embodiments of the present disclosure use the network's information to determine a suitable inter-frequency mobility configuration for one or more specific network elements in the network that have (or are predicted to have) like radio characteristics. Depending on the embodiment, suitable inter-frequency mobility configurations may be determined for one, some, or all of the network elements in the network.

In contrast to traditional approaches that adopt a single network-wide configuration strategy, embodiments of the present disclosure are able to adopt a more detailed tuning of the layer management configuration, including (but not necessarily) element-wise (e.g., cell-wise) tuning and/or clustered tuning, as may be desired. Such an approach provides an opportunity for performance improvement, e.g., by fine-tuning mobility at an appropriate level of management, considering the complexity of the task and the radio environments to be addressed. To take advantage of that opportunity, embodiments of the present disclosure learn complex relations between metrics in the overall radio environment and automate certain decision making accordingly, as will be further discussed below.

The limited network configurations addressed by traditional approaches makes it difficult to accurately estimate possible improvements or degradation in the network without adopting a trial/error approach. In contrast to approaches that are limited in this way to knowledge and experience obtained from an operator's own network (which may include a limited variety of radio scenarios from which to draw experience), embodiments may include rule-based mechanisms that are defined to determine the RF environment and impact statistics across a broader range of radio scenarios and/or may gain knowledge and experience from other networks. The ability to learn from a broader range of sources may avoid the need to trial different configurations in the network level, thereby saving time in the design, implementation, observation, and evaluation of test cases.

Embodiments described herein may reduce the metrics needed to be manually analyzed, as such manual analysis is often not time efficient and may be subject to biases resulting from individual personnel knowledge and experience. Such manual efforts also tend not to be scalable and can result in inconsistencies or bias in one or more decision making processes.

Certainly, traditional techniques have aimed to optimize mobility trigger points between particular elements (e.g., from cell A to cell B). One such example is Automated Mobility Optimization (AMO) (sometimes identified by FAJ 121 3035). Notwithstanding, embodiments of the present disclosure are directed to address optimization within a wider scope to meet the needs of operators, e.g., to identify an improved mobility strategy among a cell and all of its neighboring elements in a target frequency.

Moreover, in contrast to the decisions of AMO (which determine whether to speed up or delay mobility based on handover (HO) performance failures and oscillation metrics), embodiments of the present disclosure may leverage user experience metrics such as throughput or the quality of calls in reaching one or more decisions.

Another network tuning approach is known as Machine Intelligence Enabled Mobility (FAJ 121 4940), which aims to automatically tune the parameter A2 (search zone level). However, this approach does not bear out recommendations for the entire set of parameters that complete the full scope of Inter-Frequency mobility strategy. Indeed, simply tuning the A2 threshold may not have enough impact to user performance to make a significant different to network performance. Rather, such an approach may simply modify the point where a user starts measuring other frequencies, i.e., without an impact on the actual trigger point to leave current frequency.

One or more of the technical advantages discussed above may enable engineers to more easily transform operation of the network. For example, the lead time of the parameter optimization process may be shorted by avoiding the need to run multiple configuration trials to evaluate recommendations for uplink performance, making use of configurations learned in other parts of the network and/or a different network, and/or ingesting more metrics from the network (e.g., at cell and/or neighbor level) than would be feasible for a human (or other means) to analyze in making a recommendation.

Additionally or alternatively, the clusters of the network to be targeted for optimization may be identified down to cell object level, in some cases. In particular, embodiments may learn network configurations and radio performance from already collected data sources with a higher degree of precision than traditional approaches (e.g., at a cell object level) and/or for very specific radio conditions. Such a fine-degree of tuning would be entirely impractical to perform manually. By making such fine tuning actually practicable, embodiments of the present disclosure are expected to lead to improved radio performance.

Additionally or alternatively, network parameter adjustment may be done holistically, i.e., by taking into consideration the interaction of a larger number of cells (e.g., all cells) having a relationship with a given source cell. Among other things, embodiments may describe the cell and its relation neighbors as a network graph to allow inclusion of all potential impacts in surrounding areas and frequencies as a consideration when making a recommendation, for example.

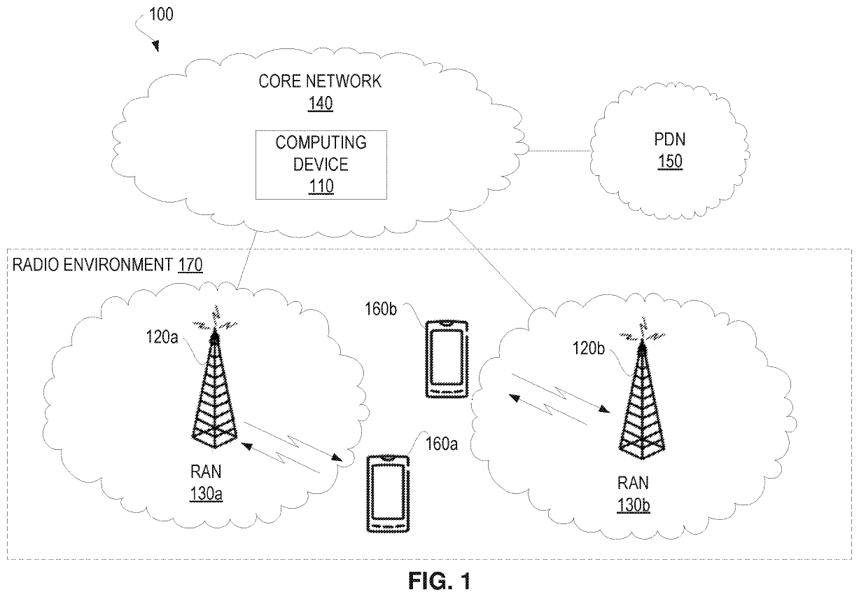

FIG. 1 illustrates an example wireless communication network 100 comprising a wireless devices 160a, 160b, a plurality of RANs 130a, 130b, a core network 140, and a Packet Data Network (PDN) 150 (e.g., the Internet). The RANs 130a, 130b are responsible for providing radio access to the core network 140 (and the PDN 150 via the core network 140) using one or more radio-related functions. Such radio-related functions may include, for example, transmission scheduling, radio resource management, and/or coding, among other things. The core network 140 is responsible for non-radio-related functions of the wireless communication network 180. Such non-radio-related functions may include, for example, authentication and/or charging, among other things.

Although each of the RANs 130a, 130b illustrated in FIG. 1 comprises a single RAN node 120a, 120b, other embodiments include one or more RANs 130 that include one or more additional RAN nodes 120. Further, although the network 100 illustrated in FIG. 1 comprises two RANs 130a, 130b, other embodiments may include any number of RANs 130.

In this example, wireless device 160a is in connected mode with RAN node 120a in RAN 130a. Accordingly, the wireless device 160a and RAN node 120a are configured to exchange signals with each other over a wireless interface. In particular, the RAN node 120a is configured to receive signals transmitted from the wireless device 160 on an uplink, and transmit signals to the wireless device 160 on a downlink. Correspondingly, the wireless device 160a is configured to receive signals transmitted from the RAN node 120a on the downlink, and transmit signals to the RAN node 120a on the uplink. Wireless device 160b is connected to RAN node 120b in RAN 130b in similar fashion. Examples of a wireless device 160 include a mobile terminal and/or user equipment (UE). Examples of a RAN node 120 include a base station and/or access node.

During operation, the RAN nodes 130a, 130b and wireless devices 160a, 160b participate in a radio environment 170 that may impact performance. For example, the radio environment 170 may be noisy or laden with a high degree of traffic. In general, when a wireless device 160 is experiencing poor radio conditions, the wireless device may handover to a neighboring cell, e.g., a cell served by a neighboring RAN node and/or a cell on another frequency. This may, in some example, include the wireless device 160 moving from one RAN 130 to another (e.g., from a 5G RAN to an LTE RAN, or vice versa).

The core network 140 comprises a computing device 110. Generally speaking, the computing device 110 is configured to receive metrics generated by the RANs 130a, 130b, the core network 140, and/or one or more of the wireless devices 160a, 160b. The computing device 110 makes one or more recommendations useful for tuning the network 100. Particular metrics considered by the computing device may be the result of measurements performed by one or more wireless devices 160 and/or one or more RAN nodes 130 with respect to the radio environment 170. Under certain conditions, the wireless device 160a, for example, may be handed over from the RAN node 120a in RAN 130a to the RAN node 120b in RAN 130b. Similarly, wireless device 160b may be handed over from the RAN node 120b in RAN 130b to the RAN node 120a in RAN 130a. In this regard, the RAN nodes 130a, 130b may serve respective cells that would provide one or more wireless devices 160 with different quality service (e.g., as a result of different signal quality, interference conditions, and/or positions of the wireless devices 160).

The cells served by the RAN nodes 130a, 130b may be on the same frequency or on different frequencies, according to embodiments. It will be appreciated that the network 100 of the various embodiments disclosed herein are not limited to the number of RANs 130, RAN nodes 120, and wireless devices 160 depicted in FIG. 1. Indeed, embodiments of the present disclosure are suitable for far more complex networks 100 than the one depicted in FIG. 1.

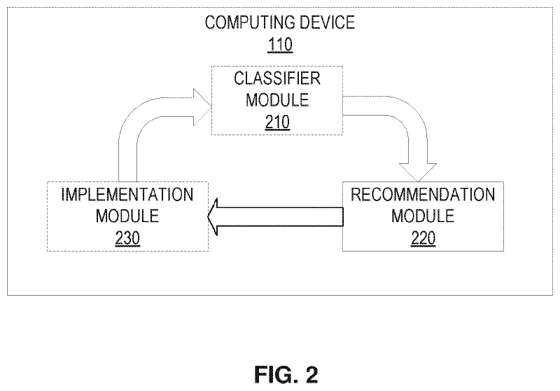

The computing device 110 implements an artificial intelligence (A1) system useful for enabling inter-frequency mobility optimization according to the overall design depicted in FIG. 2. In particular, embodiments of the computing device 110 may comprise a classifier module 210, a recommendation module 220, and an implementation module 230. The classification module 210 detects and classifies issues in the network. The recommendation module 220 provides root-cause analysis and potential actions that may be implemented in the network based on the analysis of the classification module 210. The implementation module 230 may implement one or more recommendations of the recommendation module 220 in the network 100. The resulting performance in the network 100 may be analyzed and fed back to the classifier system 210, in some embodiments.

The present disclosure focuses heavily on an intelligent mobility recommender system that may make recommendations useful for optimizing network cells by means of inter-frequency coverage-triggered mobility parameters tuning. Accordingly, embodiments of the present disclosure include a computing device 110 that includes a recommendation module 220, but not a classifier module 210 and/or implementation module 230. In some such embodiments, the classifier module 210 and/or implementation module 230 reside on a different computing device or are omitted entirely.

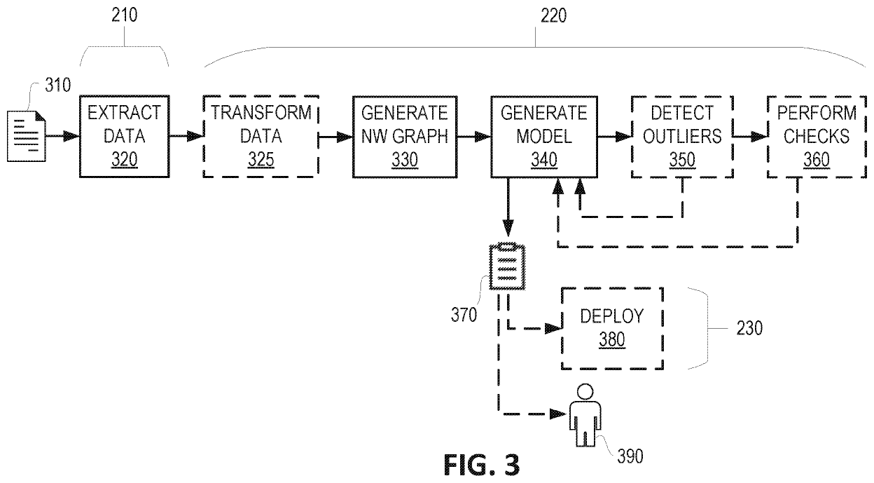

FIG. 3 is a flow diagram illustrating a high-level example process by which one or more of the improvements to traditional tuning using a classifier module 210, recommendation module 220, and implementation module 230 as discussed above may be obtained. As shown in FIG. 3, configuration and performance metrics 310 are provided as input to the computing device 110 (or other device in some embodiments, as discussed above). The configuration and performance metrics 310 are processed to extract a relevant set of indicators from a larger dataset for use in making a configuration recommendation (block 320). As will be discussed further below, the relevant set of indicators may then be processed using one or more newly-devised data structures, algorithms, and/or data models, thereby reducing the complexity of the optimization problem being faced by network performance experts seeking to tune their networks for improved performance (i.e., in contrast to the complexity of traditional manual methods currently followed by mobile operators).

The computing device 110 (or other device) may then generate a network graph that includes the important relations between network elements and indicators that describe their current radio environment 170 (block 330). In some embodiments, in order to generate the network graph, the computing device 110 may first transform the data in a variety of ways (block 325), as will be further explained below. In many embodiments, the indicators included in the network graph may be quite massive indeed. The network graph produced by the computing device 110 may describe network elements and their relations in an objective way, e.g., to mitigate the problem of personal bias or individual perception of engineers who may later be tasked with making further decisions.

The computing device 110 generates a model to learn what radio environments are generically represented by the network graph (block 340). Further, for at least one of the radio environments 170, the computing device 110 makes configuration recommendation 370 that is predicted to improve network performance. To generate the model, the computing device may make use of certain machine learning techniques as will be further described below. The configuration recommendation 370 obtained from the model may subsequently be advantageously applied to the network 100 from which the configuration and metrics data was extracted and/or to other networks (block 380). By applying the configuration recommendation 370 to other networks, the limited set of configurations used by a specific mobile operator based on knowledge of their own network may be improved. The model's ability to manage even a huge amount of performance indicators represented in the network graph in some embodiments, allows the solution to represent the radio environment 170 with significant more detail that what a human can analyze for a large set of networks cells, for example. Additionally or alternatively, the configuration recommendation 370 may be provided to a user 390, e.g., for further analysis, tuning, and/or application thereof to the network 100 and/or one or more other networks.

The computing device 110 (or other device) may then detect outliers among the network elements (block 350). That is, the computing device 110 may detect network elements that have a significantly different radio behavior as compared with the network elements for which a configuration solution was learned. The detection of outliers may help to implement changes and forecast expected benefits. Moreover, the computing device 110 may estimate an expected performance change for one or more recommendations, which may be provided to the user 390. Using this process, the trial-error approach normally followed by operators may be reduced, since low-consistency recommendations may, in some embodiments, be automatically discarded, thus heavily improving process efficiency.

The computing device 110 (or other device) may additionally or alternatively perform one or more checks (block 360). These checks may include the application of a rule-based analysis. The analysis may, for example, identify recommendations that do not fulfill operator-criteria, assist users in understanding one or more reasons for making the recommendation, and/or identify potential inconsistencies introduced in the network if the changes were to be applied, e.g., based on domain expertise. In some embodiments, the information learned from detecting outliers and/or performing checks may be used by the computing device 110 to improve the model, and generate one or more new or revised configuration recommendations for one or more of the radio environments 170 represented in the network graph.

Having reviewed the overall process illustrated in FIG. 3 at a high level, a more detailed example will be discussed in greater depth. In one particular embodiment, the extraction of relevant metrics (block 320) comprises the extraction of one or more of the following performance metrics, each of which may have a strong correlation with mobility layer management in a network 100:
Average Active Users in Downlink
Average Active Users in Uplink
Maximum RRC Connected Users
Data Volume in Downlink DRB
Data Volume in Uplink DRB
Average Downlink PRB Utilization
Average Uplink PRB Utilization
Average PUSCH Signal-to-Noise Ratio
Average PUCCH Signal-to-Noise Ratio
Average Uplink Pathloss
Required 8 CCE Rate
Downlink QPSK Modulation Rate
Uplink QPSK Modulation Rate
PUCCH Scheduling Request Failure Rate
Intra-Frequency Handover Execution Success Rate
Inter-Frequency Handover Execution Success Rate
Infra-Frequency Handover Oscillation Rate
Handover Attempt per RRC Connection Request
M IMO Usage Rate
RRC Connection Re-establishment Success Rate
ERAB Releases due to UE Lost
Intra-Frequency Handover Too Early Rate
Inter-Frequency Handover Too Early Rate
Intra-Frequency Handover Too Late Rate
Inter-Frequency Handover Too Late Rate
Intra-Frequency Handover Wrong Cell Rate
Inter-Frequency Handover Wrong Cell Rate
A2 Events Critical per Call
Average Downlink HARQ DTX
Average POOCH CCE Load
PDCCH Downlink Scheduling Rate
RLC Uplink Block Error Rate
M IMO User Rank Reported Ratio
Average Downlink User Throughput
Average Uplink User Throughput
ERAB Retainability
Uplink Pathloss Above 130 db Rate
PUCCH Signal-to-Noise Ratio Below 0 db Rate
PUSCH Signal-to-Noise Ratio Below 2 db Rate
Uplink TB Power Limited Rate
Average CQI
CQI Below 6 Rate
Number RRC Connection Establishment Attempt

More particularly, a plurality of the extracted factors when considered together may represent a type of radio environment 170 in the network 100. In this regard, one or more cells in the network 100 may be experiencing the same specific situation. One or more of these metrics may be obtained directly from another element in the network 100, or may be calculated by the computing device 110, depending on the embodiment.

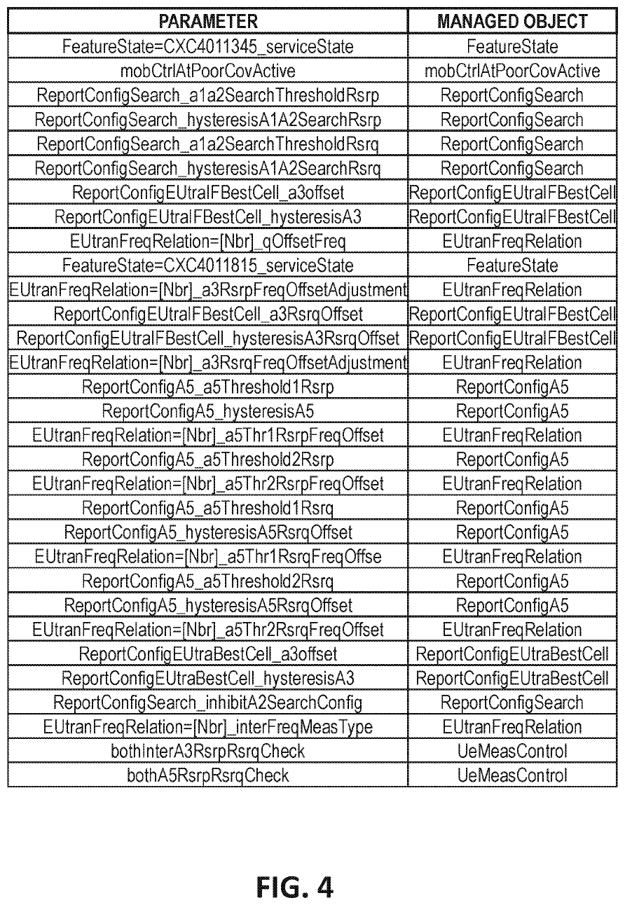

A plurality of configuration parameters is also extracted. From the extracted configuration parameters, the computing device 110 may determine a current mobility strategy configured in the network, e.g., for each cell. The table illustrated in FIG. 4 includes a list of the configuration parameters that may be extracted, according to one or more embodiments of the present disclosure.

Returning to FIG. 3, the extracted data (e.g., metrics and/or configuration data) may be transformed in one or more respects (block 325). For example, in some embodiments, transforming the data may comprise converting one or more performance metrics and/or configuration parameters into one or more other inputs that will be a basis upon which the machine learning model will recommend tuning actions.

In one such example, the computing device 110 may calculate one or more thresholds relating to mobility. Traditionally, layer management configuration is performed using a set of thresholds that act as trigger points for certain mobility actions. Offsets to these thresholds may be used to modify these original trigger points (e.g., by speeding up or delaying the triggering of certain actions). In some embodiments, the transformation of the data comprises calculating one or more “effective thresholds”, i.e., the actual trigger point for certain actions to occur. For example, the computing device 110 may calculate one or more parameters representing RF Conditions (e.g., Reference Signal Received Power (RSRP) and/or Reference Signal Received Quality (RSRQ)) per target frequency. In this regard, any one or more features and parameters that may modify those thresholds (e.g., one or more of the parameters listed in the table of FIG. 4) may be considered in the calculation.

The calculated thresholds may correspond to particular handover events. LTE, for example, defines a plurality of handover events, including the A2, A3, and A5 events. The A2 event traditionally triggers when signal quality in the serving cell is worse than a threshold. The A3 event traditionally triggers when signal quality of a neighboring cell becomes better than a threshold. The A5 event traditionally triggers when both the signal quality of the serving cell becomes worse than a threshold and the signal quality of a neighboring cell becomes better than another threshold (i.e., both threshold conditions must traditionally be met to trigger the A5 event). Several other handover events are also defined by 3GPP standards (e.g., A1, A4, B1, B2).

Embodiments of the present disclosure include calculating one or more thresholds for one or more handover events. Depending on the embodiment, these thresholds may include (but are not limited to) one or more of the following:
An RSRP threshold for triggering the A2 event
An RSRQ threshold for triggering the A2 event
An RSRP threshold for triggering the A3 event
An RSRQ threshold for triggering the A3 event
An RSRP threshold of a serving cell for triggering the A5 event
An RSRQ threshold of a serving cell for triggering the A5 event
An RSRP threshold of a neighboring cell for triggering the A5 event
An RSRQ threshold of a neighboring cell for triggering the A5 event

Transformation of the data may additionally or alternatively include other operations. For example, an input dataset from an operator network may have a certain temporal resolution (e.g., 15 minutes). Embodiments of the present disclosure may include aggregating the input to reduce noise on the radio metrics, which can vary a lot throughout the day. For example, night hours tend to have lower traffic relative to more busy daytime hours. Aggregation may enhance the performance of the ML models being evaluated and simplify the recommendations made therefrom, considering the global performance that every network element has during the whole day. A normalization process may also be performed after data aggregation, e.g., in order to have all metrics represented in the same range.

As mobility management heavily relates to the interaction between neighboring cells, embodiments of the present disclosure generate a data structure in which relevant neighbors of the same frequency and other frequencies are represented. In particular, embodiments of the present disclosure generate a network graph based on the extracted data discussed above (block 330).

In some embodiments, generating the network graph includes generating a structure in which, for every cell in the network, the following information is included:
Top N relations for same frequency and their radio environment metrics
Top N relations for Top X target frequencies and their radio environment metrics.
Relation strength for each of those neighbor relations

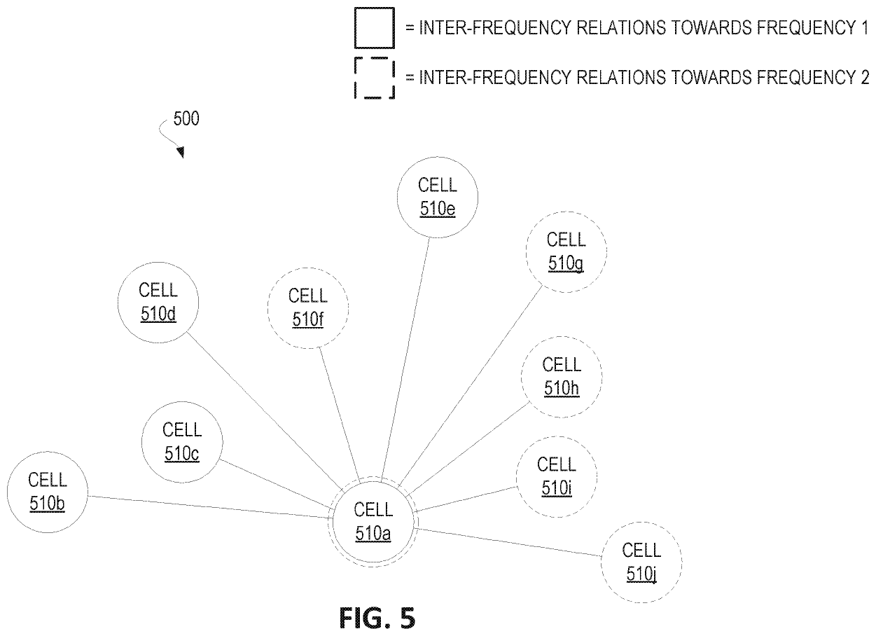

An example of such a network graph 500 is illustrated in FIG. 5. The network graph 500 of FIG. 5 includes a plurality of cells 510a-j. In this example, each of the cells 510b-j is a neighbor of cell 510a. In particular, cell 510a has an inter-frequency relationship with each of cells 510b-e on a first frequency, and an inter-frequency relationship with each of cells 510f-j on a second frequency. In this regard, cells 510b-e may be the top four relations that cell 510a has on the first frequency, and cells 510N may be the top five relations that cell 510a has on the second frequency. Other network graphs 500 may include any number of cells 510 on any number of frequencies, depending on the embodiment. In general, the network graph 500 may represent radio metrics and/or relation strength for each relationship that one or more network elements has within the network 100.

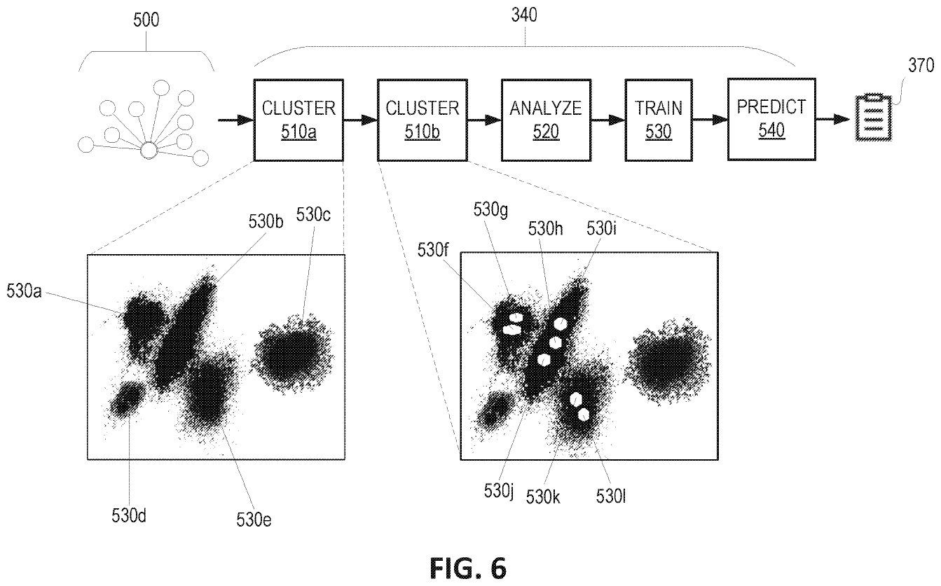

Model generation (FIG. 3, block 340) is shown in greater detail in FIG. 6. FIG. 6 illustrates an example of model generation in which a network graph 500 representing different networks and different type of radio conditions and topologies may be used to generate a training set of configurations per radio environment 170 (through blocks 510a, 510b, 520). Feeding the model with this training set enables the model to learn which configuration recommendation 370 to make. In contrast, if all data of a RAN network were to be used as a training set, the model would likely learn from a lot of samples in which the actual configuration is highly suboptimal.

Accordingly, the transformed data representing the network elements and relations are encoded to reduce the massive number of features to a smaller latent space in order to perform clustering using that reduced number of features. This reduced data set is represented in FIG. 6 by network graph 500. In order to find radio environments 170 present in the data, an agglomerative clustering technique known as Hierarchical Density-Based Spatial Clustering of Applications with Noise (HDBSCAN) may be applied to the latent space two times (blocks 510a, 510b). Given the use of multiple passes of clustering to recognize classes of information represented in the network graph 500, the configuration recommendation(s) 370 produced by embodiments may be considered to be generated by a deep neural network model, as will be shown below.

The first time that clustering is performed (block 510a), the goal is to identify the different radio environments 170. To do so, an HDBSCAN may be performed using a minimum cluster size, a minimum number of samples, and allowing for the creation of multiple clusters, for example. In particular, the minimum cluster size (min_cluster_size), which represents the minimum number of samples required to consider a group of samples to be its own independent cluster, may be set to, e.g., 1750 samples. The minimum samples (min_samples) may, e.g., be set to 10, which prevents the creation of clusters that are too small. Removal of the constraint for creating one big cluster from this analysis may be performed by setting a parameter (allow_single_cluster) to true. In the example of FIG. 6, the first pass HDBSCAN results in the identification of five clusters (530a-e).

To provide a more complete information for Network Design and Optimization (NDO) domain analysis, a second clustering pass (block 510b) may be performed. To do so, HDBSCAN may be applied a second time to try to extract different behaviors within each of the identified clusters. In this regard, tuning of the HDBSCAN parameters may be performed to obtain the results of the second pass. For example, the minimum cluster size (min_cluster_size) may be set to 500. In this example, the second pass HDBSCAN results in the identification of two clusters 530f, 530g within cluster 530a; three clusters 530h-j within cluster 530b; and two clusters 530k, 5301 within cluster 530e.

As can be seen in the results, in the first clustering pass (block 510a) the samples for each radio environment 170 were identified. In the second clustering pass (block 510b) there was more granularity with the radio environments 170. However, not all the samples for each radio environment 170 were identified. Combining information from both passes provides a better picture of the radio environments 170.

The computing device 110 and/or one or more optimization experts may then review the different radio environments 170, network topology, and frequency relation that each cluster defines (as generically described within the model), and analyze which is the optimal mobility configuration from a domain perspective for each situation in each of the clusters 530a-l (block 520). The result is a training set of configurations that may be used to train the model (block 530).

At the training stage, the model takes the training data generated from the previous analysis. The training may include obtaining the input source cell features and the neighboring cells features from the network graph 500 data structure, to which standard scaler and Synthetic Minority Oversampling Technique (SMOTE) resampling may be applied. The Standard scaler centers the data by subtracting the mean of the individual features and scales the data by dividing with the standard deviation of the individual features. SMOTE resampling can help to ensure that minority classifications of the data are sufficiently represented in the analysis such that the model can make predictions for minority classes even with relatively little data (relative to more well-represented classes). In particular, the SMOTE re-sampling may be done to increase the rate of the samples whose class frequency is below a threshold. Testing has revealed that a threshold of 100 samples produced sound results, through other thresholds may be advantageous in other embodiments.

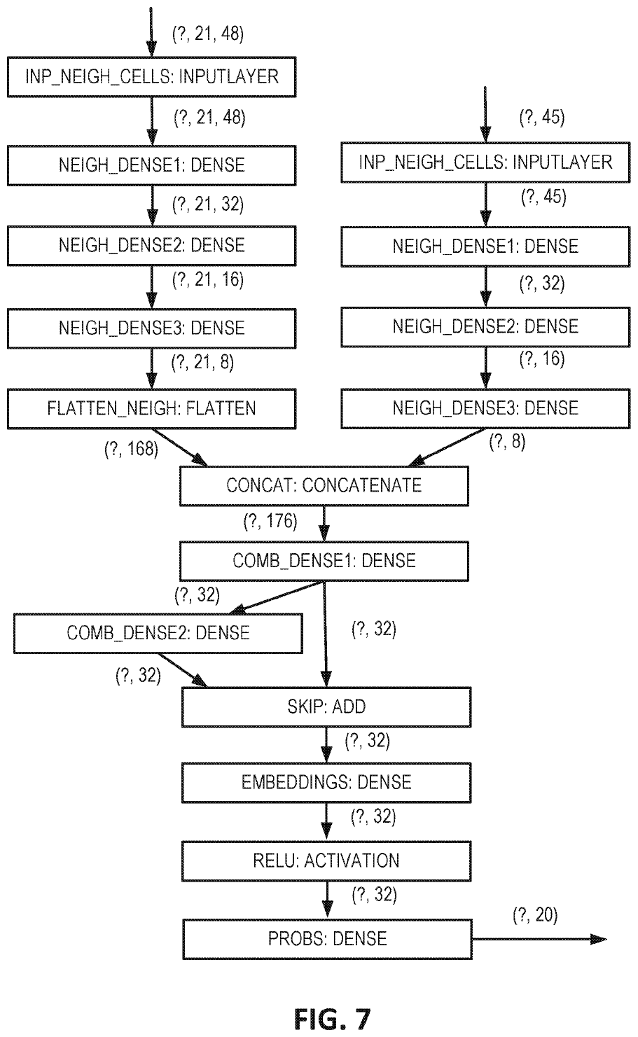

FIG. 7 illustrates an example in which the model is trained on pre-processed data using a weighted cross-entropy loss. The weights were the frequencies of each class. FIG. 7 uses a convention in which the parameters (?, N, C) represent (Batch size, Number of neighbors, Number of features) and the parameters (?, C) represents (Batch size, Number of features).

Experiments were conducted using a batch size of 128, a learning rate of 0.001 with exponential decay, and 50 epochs with early stopping criteria. Each layer of the model used a Rectified Linear Unit (ReLU) activation function except for the input layers (‘inp_neigh’ and ‘inp_source’). ReLU is a piecewise linear function that outputs the input directly if it is positive, and outputs zero otherwise. The output layer ‘probs’ used a Softmax activation function.

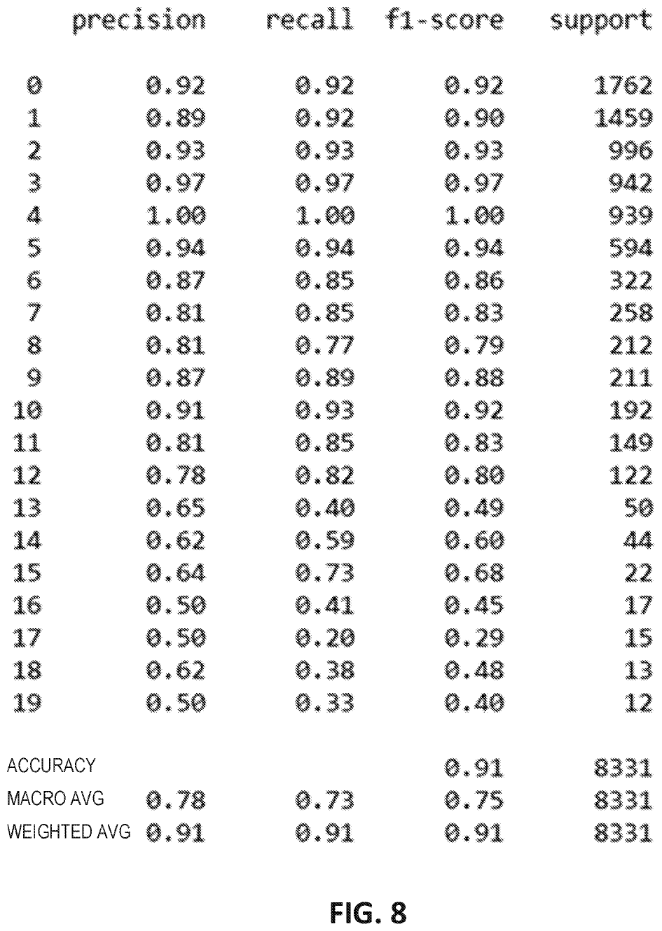

The model was validated by evaluating the F1 score (i.e., the harmonic mean of the precision and recall) and an average rank 1 score of 0.91 was achieved. The results of this validation are shown in FIG. 8. In FIG. 8, “support” represents the number of samples used for calculating the different metrics such as precision, recall and F1 score.

Returning to FIG. 6, after the model has been trained, the model may be used to predict a configuration 370 that may be applied to as yet unseen data (block 540). In experiments, the data used to make the prediction was scaled using the mean and standard deviation calculated during the training stage. The output of the model is one or more configuration recommendations 370 and their respective probability scores.

Returning now to FIG. 3, having generated the model, recommendations done by the classifier model may be automatically evaluated and analyzed. In some embodiments, outliers may be detected, e.g., in order to understand which recommendations are done for network elements that belong to a significantly different radio environment 170 than the ones already learned (block 350).

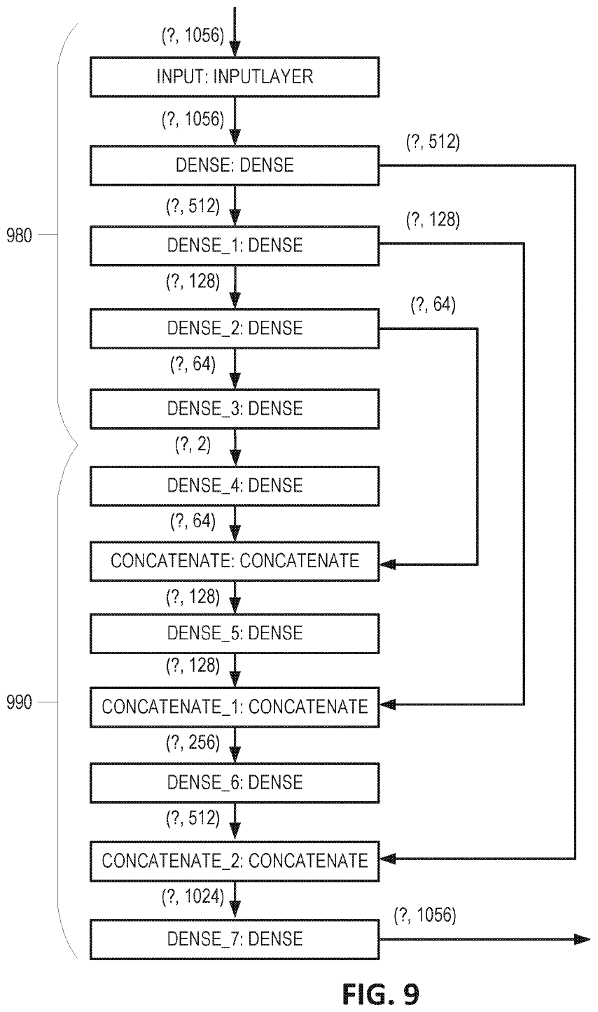

To perform outlier detection, an auto-encoder neural network following a U-net architecture may be used in which each layer on the decoder 990 is connected to the output of the previous layer and the symmetric layer in the encoder 980, as shown in the example of FIG. 9. The auto-encoder may comprise dense layers with ReLU as activation functions, for example. As shown in FIG. 9, the number of units for the encoder may be: 1056, 512, 128, 64, 2. The number of units for the decoder may be 64, 128, 512, 1056.

The result is a semantic segmentation that determines whether a particular point in the data belongs in a cluster (i.e., is part of a given classification) or is an outlier. The encoder 980 downsamples in order to encode data into representative features, and the decoder upsamples to project those features into the broader understanding. In testing, the Mean Squared Error was 0.0015.

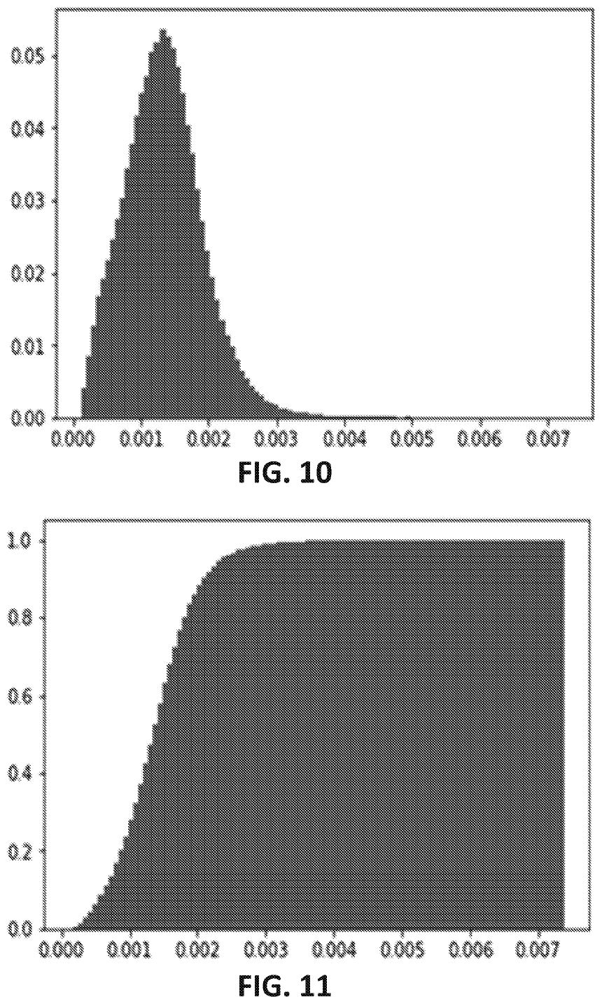

To detect samples that are different to the ones presented during training, the auto-encoder may be used as an outlier detector. First, the auto-encoder may be used to calculate a reconstruction error distribution from the training samples, and then the cumulative distribution function (CDF) of that distribution. Then the CDF may be stored for use on new samples. FIG. 10 is a graph of an example distribution error, according to one or more embodiments of the present disclosure.

When new samples are evaluated on the system, first their reconstruction error may be calculated, and then used on the CDF to obtain the outlier probability for each of the new samples. FIG. 11 is an example outlier probability graph, according to one or more embodiments of the present disclosure.

If the outlier probability is higher than a threshold, the sample may be marked as an outlier sample.

Returning to FIG. 3, the computing device 110 may perform one or more checks (block 360). These checks may include, for example, estimating, for one or more configuration recommendations 370, the change in performance. In this regard, performance may (in some embodiments) be measured by a single value metric that measures the inter-frequency mobility on a given cell. Such a metric may be calculated from several radio Key Performance Indicators (KPIs).

In one example, two functions are used to estimate the performance of the new configuration in the cell under analysis and for each neighboring cell. The first function is an expectation function that calculates, from the distribution of performance values for the recommended configuration, the performance recommended for the new sample according to the expected value of that distribution having a particular confidence interval (e.g., a 95% confidence interval).

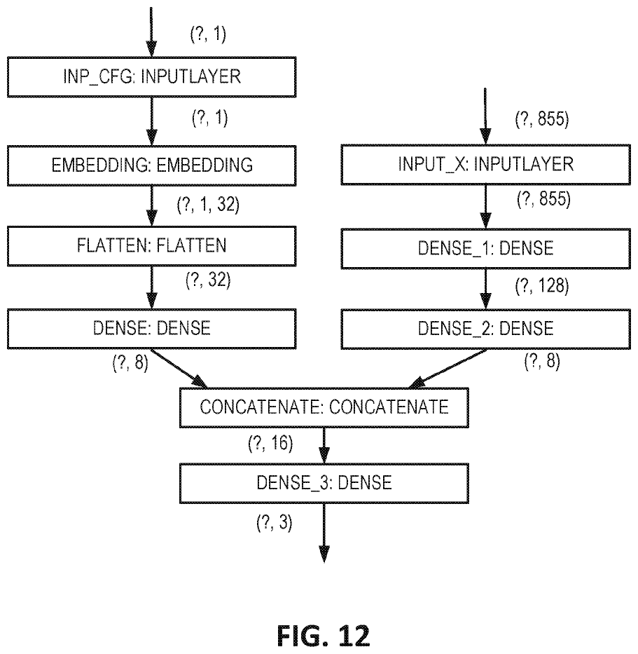

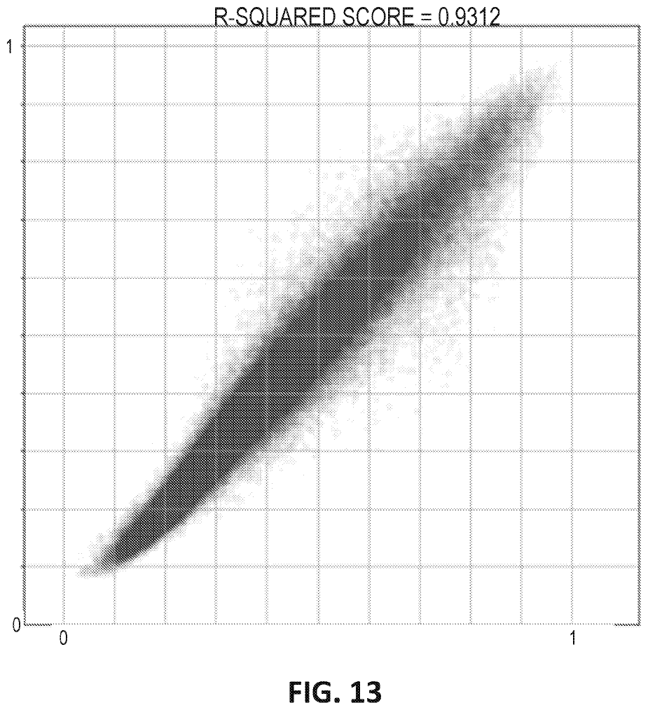

The second function is a neural network regressor function built to estimate the performance from the KPIs and configuration of a cell. The neural network regressor is composed by dense layers with ReLU activation functions, e.g., with an architecture as shown in FIG. 12. As can be observed in the example of FIG. 13, the evaluation of the neural network regressor function on the test set shows an R-squared value of approximately 0.93.

The checks performed by the computing device 110 may additionally or alternatively include one or more consistency checks and/or checks regarding domain or NDO rules. An objective of such checks may be to identify one or more configuration recommendations 370 that does not fulfill some operator-specific criteria and to help users 390 to understand the recommendations by means of summarizing the intention of the recommendation.

According to one example, the computing device 110 determines whether a configuration recommendation 370 accelerates or delays mobility with respect to a target frequency. For example, there are multiple mobility events (e.g., A2, A5, A3) and corresponding thresholds (e.g., as discussed above) that define at least aspects of inter-frequency mobility. Rather than have a user inspect multiple output parameters to realize whether a configuration recommendation 370 accelerates or delays mobility, the computing device 110 may, for example, propose a number of decibels that each trigger type (e.g., in terms of RSRP and/or RSRQ) is predicted to be tuned for the configuration recommendation 370, considering the different thresholds that can perform such change for each event type.

Additionally or alternatively, for one or more configuration recommendations 370 performed by the model, the computing device 110 may check whether the configuration recommendation 370 creates an A5th2-A2Search conflict. In an LTE network (for example), this conflict happens when the parameter threshold2 for event A5 (A5th2) for mobility towards a given Frequency X (F_X) is set to a lower value than the actual A2 Search parameter configured on the neighbor cells on F_X. If that conflict happens, users moved to F_X, may enter directly on the search zone in the new frequency right after the incoming handover. This means the user may immediately start measuring other frequencies again, potentially creating a “ping pong” effect and negatively impacting user performance.

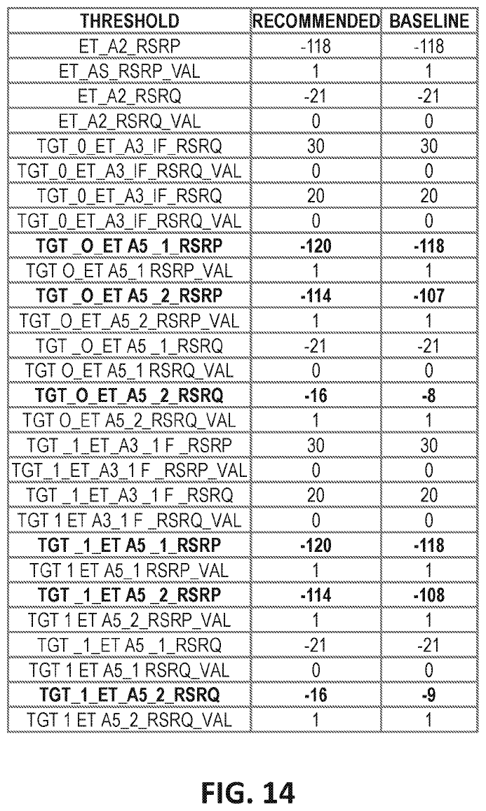

A configuration recommendation 370, according to various embodiments of the present disclosure, may take many forms. In some embodiments, the configuration recommendation 370 comprises one or more mobility thresholds to be applied by a cell in the network 100. For example, the configuration recommendation 370 may include one or more of the mobility thresholds illustrated in FIG. 14.

In FIG. 14, each of the mobility thresholds has a name that reflects a standard mobility event (e.g., A2, A3, A5), whether the threshold relates to RSRP or RSRQ, and if the mobility event relates to the signal quality of another cell, which target frequency the threshold relates to (e.g., Target Frequency 0, Target Frequency 1). Thus, in FIG. 14, TGT_0_ET_A3_IF_RSRP is the RSRP threshold for triggering mobility event A3 for target frequency 0.

FIG. 14 shows baseline and recommended values for each of the mobility thresholds. Thresholds for which a change to the baseline configuration is recommended are in bold. In general, the configuration recommendation 370 will include one or more thresholds for which a change is recommended. In some embodiments, thresholds for which no change is recommended will be excluded from the configuration recommendation. In other embodiments, one or more thresholds for which no change is recommended is included in the configuration recommendation. Indeed, a configuration recommendation 370 may include one, some, or all of the thresholds considered by the computing device 110, depending on the embodiment.

The configuration recommendation 370 may additionally or alternatively include a predicted performance change that will result upon implementation. In some embodiments, the predicted performance change is based on a regressor neural network prediction of impact of the changed configuration in the radio environment 170 of the current network element under evaluation, for example.

The configuration recommendation 370 may additionally or alternatively include a performance expectation that reflects the mean performance and intervals confidence of the prediction for the proposed configuration change. In some embodiments, this performance expectation is based on the information learned by the model and present in the training set.

The configuration recommendation 370 may additionally or alternatively include an outlier probability that indicates the probability that the radio environment for the sample of the network element being considered is significantly different (i.e., an outlier) as compared to those learned during the training process.

The configuration recommendation 370 may additionally or alternatively include a predicted signal quality change. In some embodiments, the predicted signal quality change includes, for RSRP and/or RSRQ, a summary of the direction of the change that allows users to quickly identify whether the configuration recommendation 370 accelerates or delays mobility, as compared with the baseline.

The configuration recommendation 370 may additionally or alternatively include a conflict flag that indicates whether the configuration recommendation 370 has passed a consistency check (e.g., an A5th2-A2Search Conflict check as previously discussed).

The configuration recommendation 370 may additionally or alternatively include a probability that the classification model described above has accurately recognized the radio environment 170 of this cell and proposed an appropriate recommendation. A very high probability would mean, for example, that the radio environment 170 for this cell was very well recognized by the model, and therefore the configuration recommendation 370 should be very accurate.

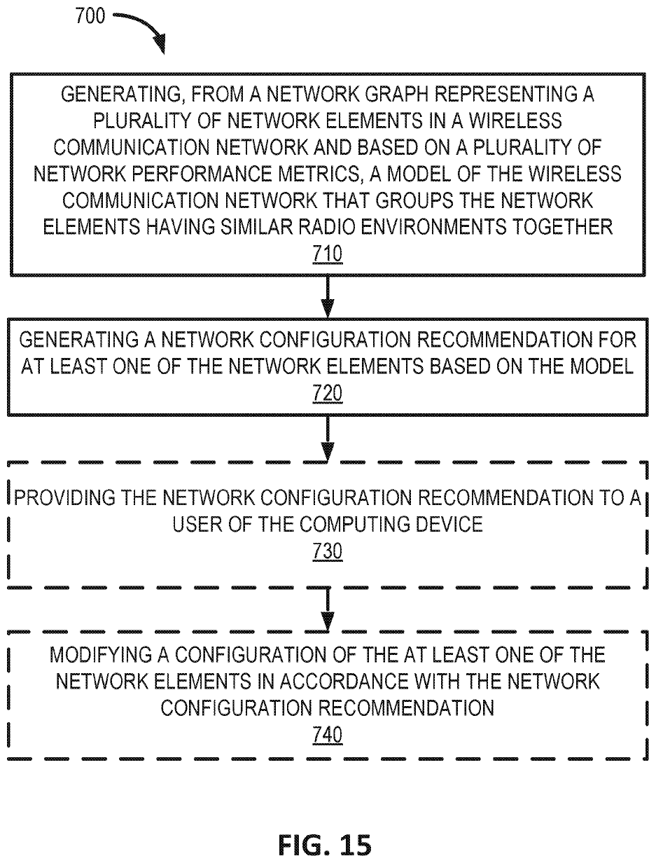

In view of all of the above and as illustrated in the example of FIG. 15, embodiments of the present disclosure include a method 700 implemented by a computing device 110. The method 700 comprises generating, from a network graph 500 representing a plurality of network elements in a wireless communication network 100 and based on a plurality of network performance metrics, a model of the wireless communication network 100 that groups 530 the network elements having similar radio environments together (block 710). The method 700 further comprises generating a network configuration recommendation 370 for at least one of the network elements based on the model (block 720).

In some embodiments, the method 700 further comprises providing the network configuration recommendation to a user 390 of the computing device 110 (block 730). In some embodiments, the method 700 additionally or alternatively comprises modifying a configuration of the at least one of the network elements in accordance with the network configuration recommendation 370 (block 740).

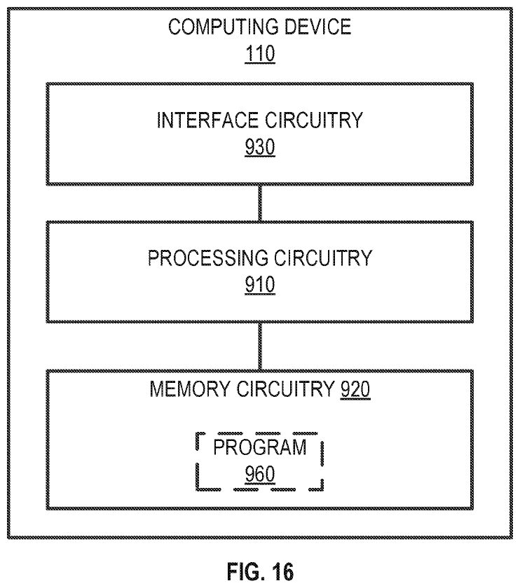

Other embodiments include a computing device 110 implemented according to the hardware illustrated in FIG. 16. The example hardware of FIG. 16 comprises processing circuitry 910, memory circuitry 920, and interface circuitry 930. The processing circuitry 910 is communicatively coupled to the memory circuitry 920 and the interface circuitry 930, e.g., via one or more buses. The processing circuitry 910 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 910 may be programmable hardware capable of executing software instructions stored, e.g., as a machine-readable computer program 960 in the memory circuitry 920. The memory circuitry 920 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 930 may be a controller hub configured to control the input and output (I/O) data paths of the computing device 110. Such I/O data paths may include data paths for exchanging signals over a communications network 100 and/or data paths for exchanging signals with a user 390. For example, the interface circuitry 930 may comprise a transceiver configured to send and receive communication signals over one or more of a cellular network, Ethernet network, or optical network. The interface circuitry 930 may also comprise one or more of a graphics adapter, display port, video bus, touchscreen, graphical processing unit (GPU), display port, Liquid Crystal Display (LCD), and Light Emitting Diode (LED) display, for presenting visual information to a user. The interface circuitry 930 may also comprise one or more of a pointing device (e.g., a mouse, stylus, touchpad, trackball, pointing stick, joystick), touchscreen, microphone for speech input, optical sensor for optical recognition of gestures, and keyboard for text entry.

The interface circuitry 930 may be implemented as a unitary physical component, or as a plurality of physical components that are contiguously or separately arranged, any of which may be communicatively coupled to any other, or may communicate with any other via the processing circuitry 910. For example, the interface circuitry 930 may comprise output circuitry (e.g., transmitter circuitry configured to send communication signals over the communications network 100) and input circuitry (e.g., receiver circuitry configured to receive communication signals over the communications network 100). Similarly, the output circuitry may comprise a display, whereas the input circuitry may comprise a keyboard. Other examples, permutations, and arrangements of the above and their equivalents will be readily apparent to those of ordinary skill.

According to embodiments of the hardware illustrated in FIG. 16, the interface circuitry 930 is configured to output a network configuration recommendation. The processing circuitry 910 is configured to generate, from a network graph 500 representing a plurality of network elements in a wireless communication network 100 and based on a plurality of network performance metrics, a model of the wireless communication network 100 that groups the network elements having similar radio environments together. The processing circuitry 910 is further configured to generate the network configuration recommendation 370 for at least one of the network elements based on the model.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-25. (canceled)

26. A method, implemented by a computing device, the method comprising:
generating, from a network graph representing a plurality of network elements in a wireless communication network and based on a plurality of network performance metrics, a model of the wireless communication network that groups the network elements having similar radio environments together;
generating a network configuration recommendation for at least one of the network elements based on the model; and
modifying a configuration of the at least one of the network elements in accordance with the network configuration recommendation.

27. The method of claim 26, wherein generating the model is further based on configurations of the network elements and a training set of configurations for the radio environments.

28. The method of claim 26, further comprising:
receiving configuration and performance metric data describing the wireless communication network; and
generating the network graph from the configuration and performance metric data and at least one signal quality threshold for each of a plurality of handover events for each of the network elements.

29. The method of claim 26, further comprising:
identifying, as behavioral outliers, one or more network elements that are represented in the network graph and omitted from the groups of network elements having similar radio environments;
wherein generating the network configuration recommendation based on the model comprises generating the network configuration recommendation based on a portion of the model that excludes the one or more network elements identified as behavioral outliers.

30. The method of claim 26, further comprising applying rule-based criteria to determine whether configuring the wireless communication network in accordance of the network configuration recommendation would produce a mobility ping-pong effect.

31. The method of claim 26, further comprising:
aggregating the network performance metrics into fewer network performance metrics;
wherein generating the model based on the plurality of network performance metrics is responsive to determining the radio environments that are similar based on the fewer network performance metrics.

32. The method of claim 26, wherein the network graph representing the plurality of network elements in the wireless communication network further represents a plurality of operator networks, each of which comprises at least one of the network elements.

33. The method of claim 26, wherein generating the model that groups the network elements having similar radio environments together comprises:
determining a preliminary group of network elements; and
identifying at least two of the groups of network elements from within the preliminary group of network elements, the at least two of the groups having radio environments are different from each other.

34. The method of claim 26, wherein generating the network configuration recommendation for the at least one of the network elements comprises generating the network configuration recommendation for one of the groups of network elements having a similar radio environment.

35. The method of claim 26, wherein the network configuration recommendation comprises:
an indication of whether the network configuration recommendation is predicted to accelerate or delay mobility within the wireless communication network; and/or
a recommended threshold for triggering a mobility event; and/or
an indication of a predicted performance impact that will be caused by adopting the network configuration recommendation; and/or
a probability that the radio environment of the at least one of the network elements for which the network configuration recommendation was generated is a behavioral outlier relative to the groups of network elements having similar radio environments.

36. A computing device comprising:
processing circuitry and a memory, the memory containing instructions executable by the processing circuitry whereby the computing device is configured to:
generate, from a network graph representing a plurality of network elements in a wireless communication network and based on a plurality of network performance metrics, a model of the wireless communication network that groups the network elements having similar radio environments together;
generate a network configuration recommendation for at least one of the network elements based on the model; and
modify a configuration of the at least one of the network elements in accordance with the network configuration recommendation.

37. The computing device of claim 36, wherein generating the model is further based on configurations of the network elements and a training set of configurations for the radio environments.

38. The computing device of claim 36, further configured to:
receive configuration and performance metric data describing the wireless communication network; and
generate the network graph from the configuration and performance metric data and at least one signal quality threshold for each of a plurality of handover events for each of the network elements.

39. The computing device of claim 36, further configured to:
identify, as behavioral outliers, one or more network elements that are represented in the network graph and omitted from the groups of network elements having similar radio environments;
wherein to generate the network configuration recommendation based on the model the computing device is configured to generate the network configuration recommendation based on a portion of the model that excludes the one or more network elements identified as behavioral outliers.

40. The computing device of claim 36, further configured to apply rule-based criteria to determine whether configuring the wireless communication network in accordance of the network configuration recommendation would produce a mobility ping-pong effect.

41. The computing device of claim 36, further configured to:
aggregate the network performance metrics into fewer network performance metrics;
wherein the computing device is configured to generate the model based on the plurality of network performance metrics responsive to determining the radio environments that are similar based on the fewer network performance metrics.

42. The computing device of claim 36, wherein the network graph representing the plurality of network elements in the wireless communication network further represents a plurality of operator networks, each of which comprises at least one of the network elements.

43. The computing device of claim 36, wherein to generate the model that groups the network elements having similar radio environments together, the computing device is configured to:
determine a preliminary group of network elements; and
identify at least two of the groups of network elements from within the preliminary group of network elements, the at least two of the groups having radio environments are different from each other.

44. The computing device of claim 36, wherein to generate the network configuration recommendation for the at least one of the network elements, the computing device is configured to generate the network configuration recommendation for one of the groups of network elements having a similar radio environment.

45. The computing device of claim 36, wherein the network configuration recommendation comprises:
an indication of whether the network configuration recommendation is predicted to accelerate or delay mobility within the wireless communication network; and/or
a recommended threshold for triggering a mobility event; and/or
an indication of a predicted performance impact that will be caused by adopting the network configuration recommendation; and/or
a probability that the radio environment of the at least one of the network elements for which the network configuration recommendation was generated is a behavioral outlier relative to the groups of network elements having similar radio environments.

46. A non-transitory computer readable medium storing a computer program product for controlling a computing device in a wireless communication network, the computer program product comprising software instructions that, when run on the computing device, cause the computing device to:
generate, from a network graph representing a plurality of network elements in the wireless communication network and based on a plurality of network performance metrics, a model of the wireless communication network that groups the network elements having similar radio environments together;
generate a network configuration recommendation for at least one of the network elements based on the model; and
modify a configuration of the at least one of the network elements in accordance with the network configuration recommendation.
